(19) United States
(12) Patent Application Publication
(10) Pub. No.: US 2017/0180082 A1
(43) Pub. Date: Jun. 22, 2017

(54) VEHICLE COMMUNICATION SYSTEM, VEHICLE-MOUNTED DEVICE, AND PORTABLE DEVICE

(71) Applicants: Masahiro Yamamoto, Aichi (JP); Takayuki Suzuki, Aichi (JP)

(72) Inventors: Masahiro Yamamoto, Aichi (JP); Takayuki Suzuki, Aichi (JP)

(73) Assignee: OMRON AUTOMOTIVE ELECTRONICS CO., LTD., Aichi (JP)

(21) Appl. No.: 15/382,179

(22) Filed: Dec. 16, 2016

(30) Foreign Application Priority Data
Dec. 17, 2015 (JP) 2015-246399

(51) Int. Cl. H04L 1/08; H04B 17/309; H04W 48/02; H04B 1/44

(52) U.S. Cl. CPC H04L 1/08; H04B 1/44; H04B 17/309; H04W 48/02; H04W 88/02

(57) ABSTRACT

A vehicle communication system includes: a vehicle-mounted device and a portable. The portable device further includes a noise detection unit which detects a noise, and the vehicle-mounted device includes a transmission frequency switching unit which switches a transmission frequency of a response request signal transmitted by a vehicle-mounted-device transmission unit. The portable device transmits a retransmission request signal, which requests that the response request signal he retransmitted, by the portable-device transmission unit in a case where the portable device detects the noise and the response request signal is not able to he received by a portable-device reception unit. The vehicle-mounted device switches the transmission frequency by the transmission frequency switching unit and retransmits the response request signal by the vehicle-mounted-device transmission unit in a case where the retransmission request signal is received by the vehicle-mounted-device reception unit.

### CROSS-REFERENCES TO RELATED APPLICATIONS

This application is based upon and claims the benefit of priority from Japanese Patent Application No. 2015-246399, filed on Dec. 17, 2015; the entire contents of which are incorporated herein by reference.

### FIELD

One or more embodiments of the present invention relate to a vehicle communication system in which an operation of a target mounted on a vehicle is permitted or prohibited based on a radio signal transmitted or received between a portable device carried by a user of the vehicle and a vehicle-mounted device mounted on the vehicle.

### BACKGROUND

There is a vehicle communication system in which an operation of a target mounted on a vehicle such as locking or unlocking of doors of the vehicle is permitted or prohibited based on a radio signal transmitted or received between a vehicle-mounted device mounted on the vehicle and a portable device carried by a user of the vehicle. This vehicle communication system is provided to improve security in the vehicle such as an automobile and convenience of the user.

As a communication method between the vehicle-mounted device and the portable device, there are roughly three types such as a passive entry method, a polling method, and a keyless entry method.

In the passive entry method, for example, when the user approaches or touches a door knob, a passive request switch is turned on, and the vehicle-mounted device transmits a response request signal to the portable device. In the polling method, the vehicle-mounted device transmits the response request signal in a predetermined cycle irrespective of a position of the portable device. If the portable device receives the response request signal, the portable device replies a response signal to the vehicle-mounted device. In the keyless entry method, when the user operates the portable device, the portable device transmits a remote operation signal to the vehicle-mounted device.

A frequency band (for example, low frequency (LF; long-wave) band) such as the response request signal transmitted from the vehicle-mounted device and a frequency band (for example, radio frequency (RF; high frequency) band) such as the response signal or the remote operation signal transmitted from the portable device are different from each other. If the response signal or the remote operation signal is received from the portable device, the vehicle-mounted device authenticates the portable device by using ID information included in the signal, and if the authentication succeeds, doors of the vehicle are locked or unlocked.

In all these methods, it is necessary to reliably perform wireless communication between the vehicle-mounted device and the portable device. However, if a noise (electromagnetic wave) which disturbs the wireless communication between the vehicle-mounted device and the portable device is present around the vehicle, a signal transmitted from any one device of the vehicle-mounted device and the portable device is not received by the other device, and a target is not normally operated.

Thus, for example, in JP-A-2009-33529, the portable device transmits an ACK signal to the vehicle-mounted device in a frequency belonging to a specific frequency band, as a measure against noise. Since this signal is disturbed by a noise belonging to the specific frequency band, in a case where the ACK signal is not received by the portable device and the response request signal (request signal) is not replied from the vehicle-mounted device within a predetermined time, the portable device transmits the ACK signal to the vehicle-mounted device in another frequency belonging to the specific frequency band.

In JP-A-2008-174960, in a case where the vehicle-mounted device does not receive a response from the portable device after the LF signal (request signal) is transmitted in a first frequency, the vehicle-mounted device transmits information for setting a transmission frequency to be a second frequency by using an UHF electromagnetic wave, and retransmits the LF signal in the second frequency. In a case where the response from the portable device is not received, the vehicle-mounted device transmits information for setting the transmission frequency to be a third frequency by using the UHF electromagnetic wave, and retransmits the LF signal in the third frequency.

In JP-A-2010-105645, the portable device determines whether or not a signal received by a portable-device reception antenna is noise, determines a voltage level of the noise if the received signal is the noise, and turns on or off an LED provided in the portable device in a pattern corresponding to the voltage level. Accordingly, the user recognizes a reception status of the noise based on the on or off pattern of the LED, and handles a situation, in other words, a storage space of the portable device is changed.

In JP-A-2012-184608, in the keyless entry method, when an operation unit of the portable device is operated, the portable device measures a noise level in a frequency band for use in the transmission of the vehicle-mounted device. The portable device transmits information of the measured noise level to the vehicle-mounted device, and the vehicle-mounted. device receives the information of the noise level and performs transmission control of a transmission signal to the portable device based on the information. Specifically, as the transmission control, the vehicle-mounted device switches the output of the transmission signal, switches a bit rate, or increases the number of times of the transmission is performed.

FIG. 6 is a timing chart showing an example of a communication state between a vehicle-mounted device and a portable device in the related art. For example, in the passive entry method or the polling method, the response request signal (LF signal) is transmitted from the vehicle-mounted device to the portable device in a transmission frequency of α KHz. In this case, if a noise (electromagnetic wave) having the same frequency of α KHz as that of the response request signal is present around the vehicle, the response request signal is drown in the noise, and the portable device is not able to receive the response request signal. Thus, since the portable device does not reply the response signal and the vehicle-mounted device does not permit an operation of the target, the convenience of the user may be impaired.

### SUMMARY

An object of one or more embodiments of the present invention is to secure convenience by reliably receiving a radio signal transmitted from a vehicle-mounted device by a portable device even though noise is present in a vehicle communication system that includes the portable device and the vehicle-mounted device.

A vehicle communication system according to one or more embodiments of the present invention includes: a vehicle-mounted device which is mounted on a vehicle and which includes a vehicle-mounted-device transmission unit and a vehicle-mounted-device reception unit transmits and receives radio signals, respectively; a portable device which is carried by a user of the vehicle and which includes a portable-device transmission unit and a portable-device reception unit which transmits and receives radio signals, respectively. The vehicle-mounted device transmits a response request signal by the vehicle-mounted-device transmission unit, the portable device transmits a response signal by the portable-device transmission unit in response to reception of the response request signal by the portable-device reception unit, and the vehicle-mounted device permits or prohibits an operation of a target mounted on the vehicle based on the response signal received by the vehicle-mounted-device reception unit, In such a configuration, the portable device further includes a noise detection unit which detects a noise which disturbs reception of the response request signal by the portable-device reception unit, and the vehicle-mounted device further includes a transmission frequency switching unit which switches a transmission frequency of the response request signal transmitted by the vehicle-mounted-device transmission unit. The portable device transmits a retransmission request signal, which requests that the response request signal be retransmitted, by the portable-device transmission unit in a case where the portable device detects the noise by the noise detection unit and the response request signal is not able to be received by the portable-device reception unit. The vehicle-mounted device switches the transmission frequency by the transmission frequency switching unit and retransmits the response request signal by the vehicle-mounted-device transmission unit in a case where the retransmission request signal is received by the vehicle-mounted-device reception unit.

A vehicle-mounted device according to one or more embodiments of the present invention is mounted on a vehicle, and includes a vehicle-mounted-device transmission unit and a vehicle-mounted-device reception unit which transmits and receives radio signals, respectively. A response request signal is transmitted to a portable device carried by a user of the vehicle by the vehicle-mounted-device transmission unit, and a response signal, which is transmitted in response to reception of the response request signal by the portable device, is received by the vehicle-mounted-device reception unit to permit or prohibit an operation of a target mounted on the vehicle based on the response signal. The vehicle-mounted device further includes: a transmission frequency switching unit which switches a transmission frequency of the response request signal transmitted by the vehicle-mounted-device transmission unit. The transmission frequency is switched by the transmission frequency switching unit and the response request signal is retransmitted by the vehicle-mounted-device transmission unit in a case where a retransmission request signal, which requests retransmission of the response request signal and is transmitted in response to detection of a noise which disturbs the reception of the response request signal by the portable device, is received by the vehicle-mounted-device reception unit.

A portable device according to one or more embodiments of the present invention is carried by a user of a vehicle, and the portable device includes a portable-device transmission unit and a portable-device reception unit which transmits and receives a radio signal, respectively. A response signal which permits or prohibits an operation of a target mounted on the vehicle to a vehicle-mounted device mounted on the vehicle is transmitted by the portable-device transmission unit in response to reception of a response request signal transmitted from the vehicle-mounted device by the portable-device reception unit. The portable device further includes: a noise detection unit which detects a noise which disturbs reception of the response request signal by the portable-device reception unit. The portable-device transmission unit transmits a retransmission request signal, which requests that the response request signal be retransmitted by switching a transmission frequency of the response request signal, to the vehicle-mounted device in a case where the noise is detected by the noise detection unit and the response request signal is not able to be received by the portable-device reception unit.

As stated above, even though noise (electromagnetic wave) is present around the vehicle and the portable device is not able to receive the response request signal (radio signal) transmitted from the vehicle-mounted device, the portable device detects noise by the noise detection unit, and transmits the retransmission request signal to the vehicle-mounted device. The vehicle-mounted device that receives the retransmission request signal switches the transmission frequency of the response request signal to a transmission frequency which is not disturbed by the noise by the transmission frequency switching unit, and retransmits the response request signal. Thus, the response request signal that is transmitted from the vehicle-mounted device can be reliably received by the portable device. Thereafter, the vehicle-mounted device receives the response signal transmitted from the portable device, and thus, a target mounted on the vehicle can be operated based on the response signal. Thus, it is possible to secure the convenience of the user.

In one or more embodiments of the present invention, the transmission frequency of the response request signal may belong to a first frequency band, and the respective transmission frequencies of the response signal and the retransmission request signal may belong to a second frequency band different from the first frequency band.

In one or more embodiments of the present invention, the portable device may add a switching instruction of the transmission frequency of the response request signal to the retransmission request signal, and may transmit the retransmission request signal by the portable-device transmission unit.

In one or more embodiments of the present invention, the portable device may further include a reception frequency switching unit which switches a receiving target frequency of the response request signal to be received by the portable-device reception unit, and the receiving target frequency may be switched by the reception frequency switching unit so as to match the transmission frequency of the response request signal to be retransmitted from the vehicle-mounted device later in response to transmission of the retransmission request signal by the portable-device transmission unit.

According to one or more embodiments of the invention, it is possible to secure convenience by reliably receiving a radio signal transmitted from a vehicle-mounted device by a portable device even though noise is present in a vehicle communication system that includes the portable device and the vehicle-mounted device.

### BRIEF DESCRIPTION OF THE DRAWINGS

FIG. 1 is a configuration diagram of a vehicle communication system according to an embodiment of the present invention;

FIG. 2 is a flowchart showing an operation of a vehicle-mounted device of FIG. 1;

FIG. 3 is a flowchart showing an operation of a portable device of FIG. 1;

FIGS. 4A and 4B are time charts showing an example of a communication state between the vehicle-mounted device and the portable device of FIG. 1;

FIG. 5 is a flowchart showing an operation of a vehicle-mounted device according to another embodiment; and

FIG. 6 is a timing chart showing an example of a communication state between a vehicle-mounted device and a portable device in the related art.

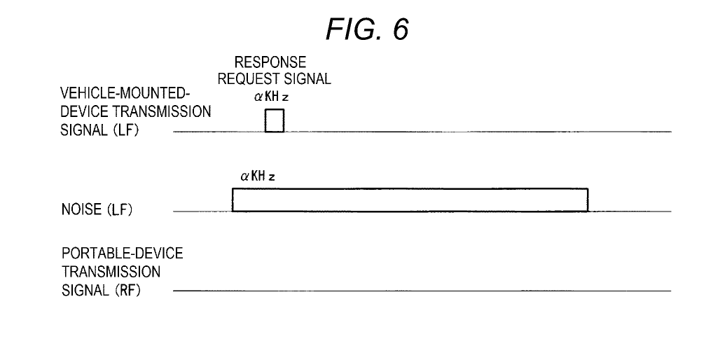

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

Hereinafter, one or more embodiment of the present invention will be described with reference to the drawings. In the respective drawings, the same portions or corresponding portions will be assigned the same reference numeral.

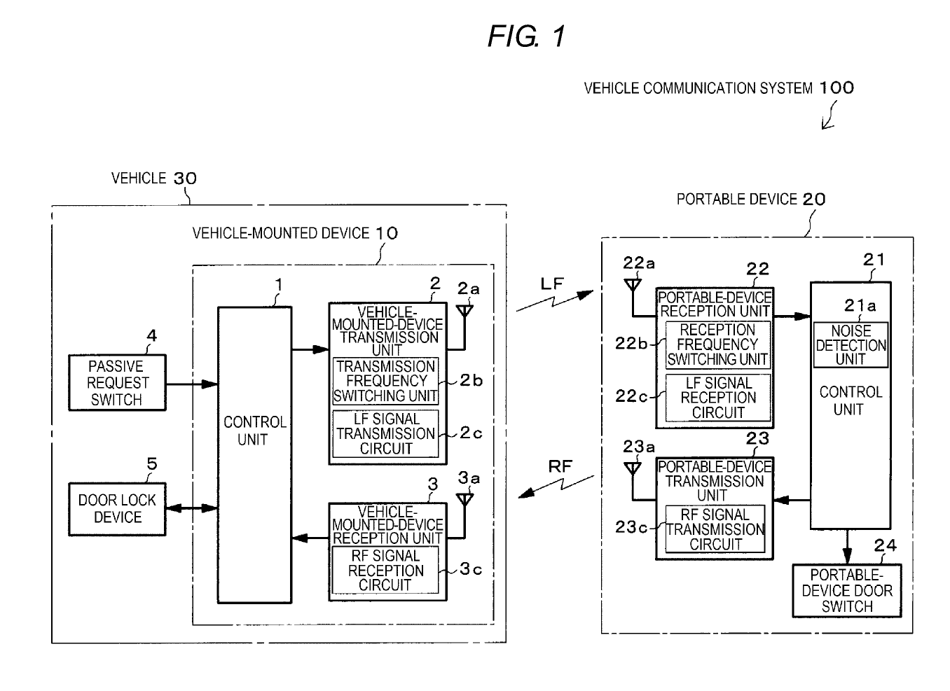

Initially, a configuration of a vehicle communication system 100 according to the embodiment will be described with reference to FIG. 1.

FIG. 1 is a configuration diagram of the vehicle communication system 100. For example, the vehicle communication system 100 includes a vehicle-mounted device 10 mounted on a vehicle 30 such as an automatic four-wheeled vehicle, and a portable device 20 carried by a user.

In the vehicle communication system 100, an operation of a target mounted on the vehicle 30 is permitted or prohibited based on a radio signal transmitted and received between the vehicle-mounted device 10 and the portable device 20. Specifically, as the target, an operation of a door lock device 5 that locks or unlocks doors of the vehicle 30 is permitted or prohibited.

The vehicle-mounted device 10 includes a control unit 1, a vehicle-mounted-device transmission unit 2, and a vehicle-mounted-device reception unit 3. The control unit 1 includes a CPU and a memory.

The vehicle-mounted-device transmission unit 2 is provided in plural number at the vehicle 30. The vehicle-mounted-device transmission unit 2 includes a transmission antenna 2a, a transmission frequency switching unit 2b, and an LF signal transmission circuit 2c.

The transmission antenna 2a is provided inside and outside of a vehicle compartment of the vehicle 30. The vehicle-mounted-device transmission unit 2 generates a radio signal of a low frequency (LF; long-wave) band using the LF signal transmission circuit 2c, and transmits the generated radio signal to the portable device 20 present inside of the vehicle compartment or outside of the vehicle compartment from the transmission antenna 2a. The radio signal transmitted from the vehicle-mounted-device transmission unit 2 includes a response request signal for requesting a response from the portable device 20.

The transmission frequency switching unit 2b switches a transmission frequency of the response request signal transmitted from the transmission antenna 2a such that the transmission frequency thereof belongs to an LF band. The LF band is an example of a “first frequency band” according to the embodiment of the present invention.

The vehicle-mounted-device reception unit 3 includes a reception antenna 3a, and an RF signal reception circuit 3c. The vehicle-mounted-device reception unit 3 receives the radio signal of the radio frequency (RF; high frequency) band transmitted from the portable device 20 by the reception antenna 3a and the RF signal reception circuit 3c.

The control unit 1 of the vehicle-mounted device 10 controls the vehicle-mounted-device transmission unit 2 and the vehicle-mounted-device reception unit 3 to perform wireless communication with the portable device 20, and performs transmission and reception of signal or information to and from the portable device 20. The control unit 1 controls the transmission frequency switching unit 2b to switch the transmission frequency of the radio signal (LF signal) transmitted from the vehicle-mounted-device transmission unit 2.

Passive request switches 4 and the door lock device 5 are connected to the control unit 1 of the vehicle-mounted device 10. The passive request switches 4 are provided at outer knobs of the doors of the vehicle 30. When a user locks or unlocks the doors of the vehicle 30, the user approaches or touches any one of the outer knobs, and thus, the passive request switches 4 are operated (switched from ON to OFF). The door lock device 5 includes mechanisms that lock or unlock the doors of the vehicle 30, and driving circuits of the mechanisms.

The portable device 20 includes a FOB key. The portable device 20 includes a control unit 21, a portable-device reception unit 22, a portable-device transmission unit 23, and a portable-device door switch 24. The control unit 21 includes a CPU and a memory. The control unit 21 includes a noise detection unit 21a.

The portable-device reception unit 22 includes a reception antenna 22a, a reception frequency switching unit 22b, and an LF signal reception circuit 22c. The portable-device reception unit 22 receives the radio signal of the LF band transmitted from the vehicle-mounted device 10 by the reception antenna 22a and the LF signal reception circuit 22c. The reception frequency switching unit 22b switches a receiving target frequency of the response request signal from the portable-device reception unit 22 such that the receiving target frequency thereof belongs to the LE band.

The noise detection unit 21a detects a noise (electromagnetic wave) that disturbs the reception of the response request signal from the portable-device reception unit 22. Specifically, for example, the noise detection unit extracts a signal having a receiving target frequency from the electromagnetic wave received by the reception antenna 22a by the LF signal reception circuit 22c. In a case where the response request signal is not detected from the extracted signal and a noise having a predetermined level or more is detected, it is determined that the noise detection unit 21a detects the noise.

The portable-device transmission unit 23 includes a transmission antenna 23a and an RF signal transmission circuit 23c. The portable-device transmission unit 23 transmits the radio signal of the RF band generated using the RF signal transmission circuit 23c to the vehicle-mounted device 10 from the transmission antenna 23a. The RF band is an example of a “second frequency band” according to the embodiment of the present invention.

The radio signal (RF signal) transmitted from the portable-device transmission unit 23 includes a response signal for responding to the aforementioned response request signal, a retransmission request signal for requesting retransmission of the response request signal, and a remote operation signal to be described below.

The portable-device door switch 24 is operated for locking or unlocking the doors of the vehicle 30. If the portable-device door switch 24 is operated, the control unit 21 generates a remote operation signal corresponding to this operation, and transmits the remote operation signal to the vehicle-mounted device 10 by the portable-device transmission unit 23.

The control unit 21 controls the portable-device reception unit 22 and the portable-device transmission unit 23 to perform wireless communication with the vehicle-mounted device 10, and performs transmission and reception of signal or information to and from the vehicle-mounted device 10.

The remote operation signal or the response signal transmitted to the vehicle-mounted device 10 from the portable device 20 by the portable-device transmission unit 23 includes ID information (identification code) of the portable device 20.

If the remote operation signal transmitted from the portable device 20 is received by the vehicle-mounted-device reception unit 3, the control unit 1 of the vehicle-mounted device 10 compares the ID information of the portable device 20 included in the remote operation signal with previously stored ID information of the vehicle-mounted device 10. If both the ID information items match each other, the control unit 1 controls the door lock device 5 based on the remote operation signal, and locks or unlocks the doors of the vehicle 30. (Keyless Entry Method)

If the user carrying the portable device 20 approaches the vehicle 30 and the passive request switch 4 is operated, the control unit 1 of the vehicle-mounted device 10 transmits the response request signal to the portable device 20 by the vehicle-mounted-device transmission unit 2. If the response request signal is received by the portable-device reception unit 22, the control unit 21 of the portable device 20 transmits the response signal to the vehicle-mounted device 10 by the portable-device transmission unit 23. If the response signal is received by the vehicle-mounted-device reception unit 3, the control unit 1 of the vehicle-mounted device 10 compares the ID information of the portable device 20 included in the response signal with the ID information of the vehicle-mounted device 10. If both the ID information items match each other, the control unit 1 controls the door lock device 5 based on the response signal, and locks or unlocks the doors of the vehicle 30. (Passive Entry Method)

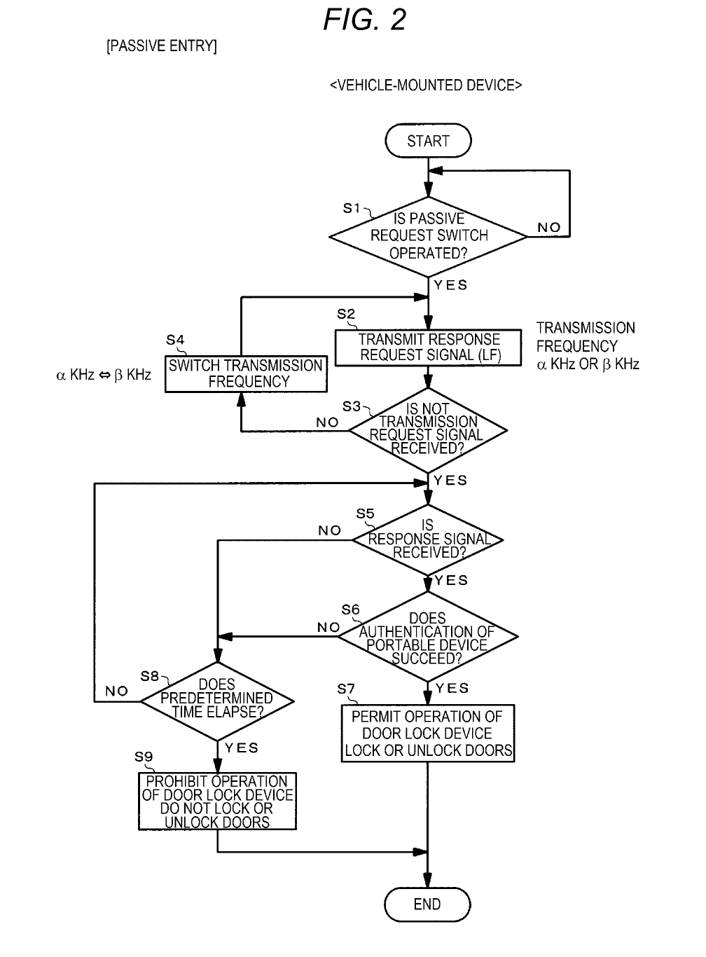

Hereinafter, operations of the vehicle-mounted device 10 and the portable device 20 will be described with reference to FIGS. 2 to 4. In the following description, an operation in the case of a passive entry method will be described as an example.

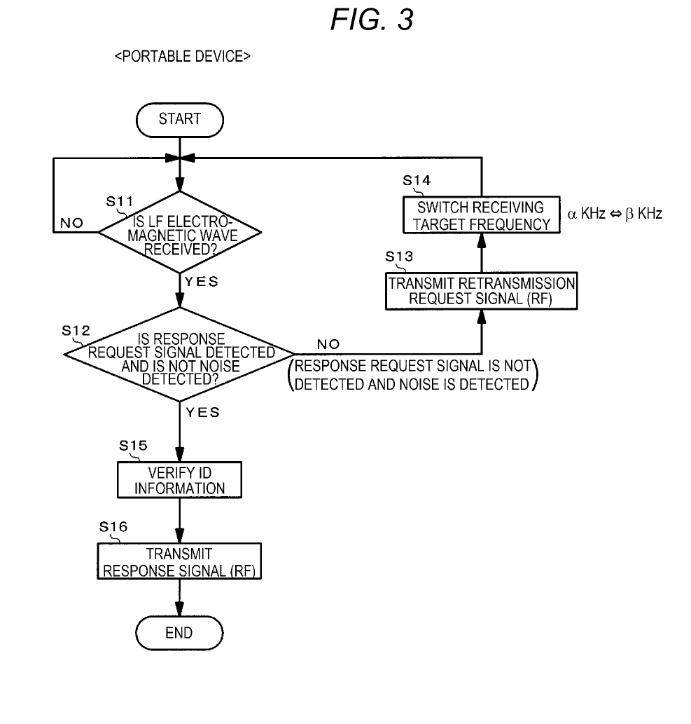

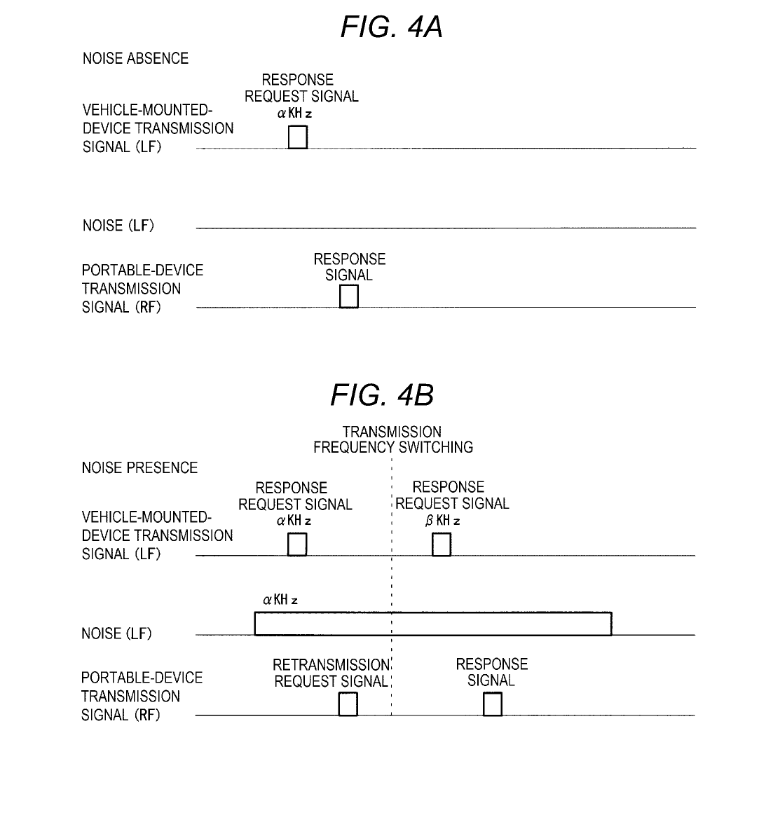

FIG. 2 is a flowchart showing the operation of the vehicle-mounted device 10. FIG. 3 is a flowchart showing the operation of the portable device 20. FIGS. 4A and 4B are timing charts showing an example of a communication state between the vehicle-mounted device 10 and the portable device 20.

When the portable device 20 is present outside of the vehicle compartment, if the passive request switch 4 of the vehicle 30 is operated by the user (step S1 of FIG. 2: YES), the control unit 1 of the vehicle-mounted device 10 transmits the response request signal (LF signal) to the portable device 20 in a transmission frequency of α KHz by the vehicle-mounted-device transmission unit 2 (step S2 of FIG. 2, FIGS. 4A and 4B). The response request signal includes ID information previously assigned to the vehicle-mounted device 10.

In the portable device 20, if the electromagnetic wave of the LF band is received by the reception antenna 22a (step S11 of FIG. 3: YES), the control unit 21 tries to detect the response request signal and the noise by the portable-device reception unit 22. In this case, the portable device extracts a signal having a receiving target frequency of α KHz from the electromagnetic wave of the LF band received by the reception antenna 22a by the LF signal reception circuit 22e of the portable-device reception unit 22. In a case where the response request signal is able to be detected from the extracted signal (reception of the response request signal is OK) and a noise having a frequency α KHz which is equal to or greater than a predetermined level is not detected by the noise detection unit 21a (step S12 of FIG. 3: YES, a no-noise state of FIG. 4A), the control unit 21 verifies the ID information of the vehicle-mounted device 10 included in the response request signal (step S15 of FIG. 3).

For example, in step S15 of FIG. 3, the control unit 21 checks whether or not the ID information of the vehicle-mounted device 10 is included in the received response request signal. Alternatively, the control unit 21 may compare the ID information of the vehicle-mounted device 10 included in the response request signal with the previously stored ID information of the portable device 20.

Meanwhile, in step S12 of FIG. 3, it is assumed that after a signal having a receiving target frequency of α KHz is extracted by the portable-device reception unit 22 from the electromagnetic wave of the LF hand received by reception antenna 22a, the response request signal is not able to be detected from the signal (reception of the response request signal is NG), and a noise having a frequency of α KHz which is equal to or greater than a predetermined level is detected by noise detection unit 21a (step S12 of FIG. 3: NO, state in which there is noise of FIG. 4B). In this case, the control unit 21 transmits a retransmission request signal (RF signal) for requesting the retransmission of the response request signal to the vehicle-mounted device 10 by the portable-device transmission unit 23 (step S13 of FIG. 3, FIG. 4B). The retransmission request signal includes a switching instruction of the transmission frequency of the response request signal to the vehicle-mounted device 10.

The control unit 21 switches the receiving target frequency from α KHz to β KHz by the reception frequency switching unit 22b such that the receiving target frequency matches the transmission frequency of the response request signal which is β KHz to be retransmitted from the vehicle-mounted device 10 later in response to transmission of the retransmission request signal (step S14 of FIG. 3). The control unit 21 waits until the electromagnetic wave of the LF band is received by reception antenna 22a (step S11 of FIG. 3).

In the vehicle-mounted device 10, if the retransmission request signal (RF signal) is received within a predetermined time after the response request signal is transmitted (step S3 of FIG. 2: NO), the control unit 1 switches the transmission frequency of the response request signal from α KHz to β KHz according to a switching instruction included in the retransmission request signal by the transmission frequency switching unit 2b (step S4 of FIG. 2). The control unit 1 retransmits the response request signal to the portable device 20 by the vehicle-mounted-device transmission unit 2 in a transmission frequency of β KHz (step S2 of FIG. 2, FIG. 4B). That is, the response request signal is retransmitted from the vehicle-mounted device 10 not in a transmission frequency of α KHz which is disturbed by noise but in a transmission frequency of β KHz which is not disturbed by noise.

Thereafter, in the portable device 20, the electromagnetic wave of the LF band is received by the reception antenna 22a (step S11 of FIG. 3: YES), the control unit 21 tries to detect the response request signal and the noise. In this case, a signal having a receiving target frequency of β KHz is extracted from the electromagnetic wave of the LF band received by the reception antenna 22a by the LF signal reception circuit 22c of the portable-device reception unit 22. Since the response request signal is able to be detected from the extracted signal and a noise having a frequency of β KHz equal to or greater than a predetermined level is not detected by the noise detection unit 21a (step S12 of FIG. 3: YES), the control unit 21 verifies the ID information of the vehicle-mounted device 10 included in the response request signal (step S15 of FIG. 3).

After the ID information is verified, the control unit 21 transmits the response signal (RF signal) to the vehicle-mounted device 10 by the portable-device transmission unit 23 (step S16 of FIG. 3, FIGS. 4A and 4B). The response signal includes the ID information previously assigned to the portable device 20.

In the vehicle-mounted device 10, the retransmission request signal (RF signal) is not received within a predetermined time after the response request signal is transmitted (step S3 of FIG. 2: YES), the response signal is received by the vehicle-mounted-device reception unit 3 (step S5 of FIG. 2: YES). By doing this, the control unit 1 verifies the portable device 20.

In this case, the control unit 1 compares the ID information of the portable device 20 included in the received response signal with the ID information of the previously stored vehicle-mounted device 10. If both the ID information items match each other, the control unit 1 determines that the authentication of the portable device 20 succeeds (step S6 of FIG. 2: YES), permits the door lock device 5 to lock or unlock the doors, and locks or unlocks the doors (step S7 of FIG. 2).

Meanwhile, the retransmission request signal and the response signal are not received after the response request signal is transmitted (step S3: YES and step S5: NO in FIG. 2), in a case where a predetermined time elapses (step S8 of FIG. 2: YES) or even though the response signal is received (step S5 of FIG. 2: YES), since the ID information of the portable device 20 included in the response signal and the ID information of the vehicle-mounted device 10 do not match each other, the authentication of the portable device 20 does not succeed (step S6 of FIG. 2: NO). In a case where the predetermined time elapses (step S8 of FIG. 2: YES), the control unit 1 prohibits the door lock device 5 to lock or unlock the doors, and does not lock or unlock the doors (step S9 of FIG. 2).

According to the above-described embodiment, even though noise (electromagnetic wave) is present around the vehicle 30 and the response request signal (LF signal) transmitted from the vehicle-mounted device 10 is not able to be received by the portable device 20, the portable device 20 detects the noise by the noise detection unit 21a, and transmits the retransmission request signal to the vehicle-mounted device 10. The vehicle-mounted device 10 that receives the retransmission request signal switches the transmission frequency of the response request signal to the transmission frequency which is not disturbed by the noise by the transmission frequency switching unit 2b, and retransmits the response request signal. Thus, the response request signal transmitted from the vehicle-mounted device 10 is able to be reliably received by the portable device 20. Thereafter, the vehicle-mounted device 10 receives the response signal transmitted from the portable device 20 and operates the door lock device 5 mounted on the vehicle 30 based on the response signal, and thus, the doors can be locked or unlocked. Accordingly, it is possible to secure convenience of the user.

In the above-described embodiment, the transmission frequency of the response request signal belongs to the LF band and the respective transmission frequencies of the response signal and the retransmission request signal belong to the RF band. Thus, the reception of the response signal or the retransmission request signal transmitted from the portable device 20 by the vehicle-mounted device 10 is not disturbed by the noise which disturbs the reception of the response request signal transmitted from the vehicle-mounted device 10 by the portable device 20 and belongs to the LF band.

In the above-described embodiment, the portable device 20 adds the switching instruction of the transmission frequency of the response request signal to the retransmission request signal, and transmits the retransmission request signal to the portable-device transmission unit 23, thus, the vehicle-mounted device 10 that receives the retransmission request signal from the portable device 20 reliably switches the transmission frequency of the response request signal to the transmission frequency that is not disturbed by the noise based on the switching instruction included in the retransmission request signal, and can retransmit the response request signal.

In the above-described embodiment, the portable device 20 switches the receiving target frequency by the reception frequency switching unit 22b such that the receiving target frequency matches a transmission frequency of a response request signal to be retransmitted from the vehicle-mounted device 10 later in response to the transmission of the retransmission request signal by the portable-device transmission unit 23. Accordingly, the response request signal retransmitted from the vehicle-mounted device 10 is able to be more reliably received by the portable device 20.

Even though a noise having the same frequency as the transmission frequency of the response request signal retransmitted from the vehicle-mounted device 10 is abruptly caused nearby and the response request signal is not received by the portable device 20 again, the noise can be reliably detected by the noise detection unit 21a. In this case, the portable device 20 transmits the retransmission request signal to the vehicle-mounted device 10 again (step S13 of FIG. 3), the vehicle-mounted device 10 that receives the retransmission request signal can switch the transmission frequency of the response request signal by the transmission frequency switching unit 2b again (returns the transmission frequency from β KHz to α KHz) (step S4 of FIG. 2). The vehicle-mounted device 10 can further again retransmit the response request signal (step S2 of FIG. 2), and the portable device 20 can receive the response request signal.

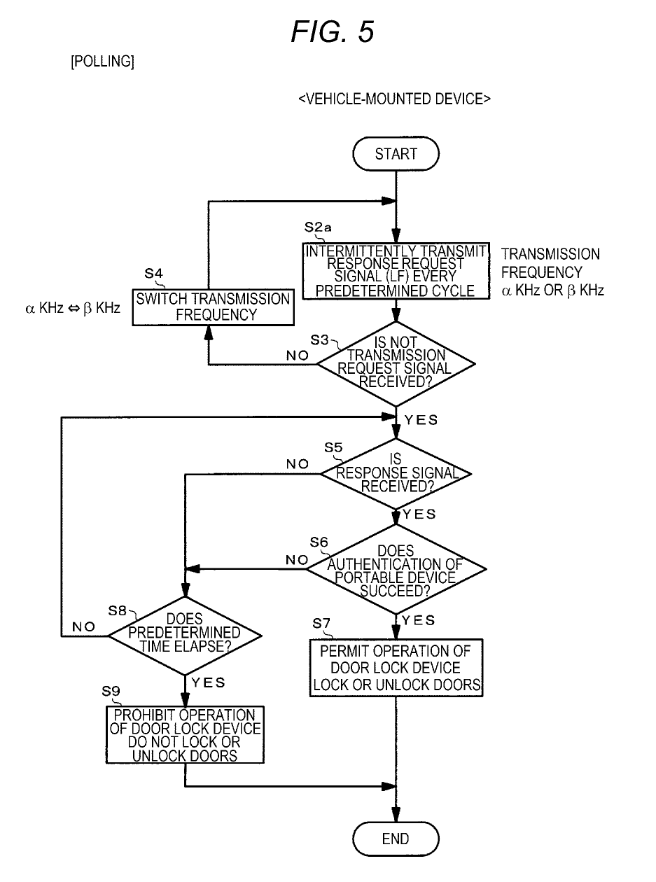

The present invention may adopt various embodiments in addition to the above-described embodiment. For example, although the case (passive entry method) where the response request signal is transmitted from the vehicle-mounted device 10 in response to the operation of the passive request switch 4 (step S1 of FIG. 2: YES) has been described in the above-described embodiment, the present invention is not limited thereto. In addition, for example, the present invention may also be applied to a case (polling method) where the response request signal is intermittently transmitted from the vehicle-mounted-device transmission unit 2 in a predetermined cycle irrespective of the switch operation, as shown in FIG. 5.

In the example of FIG. 5, when the portable device 20 is present outside of the vehicle compartment, the vehicle-mounted device 10 intermittently transmits the response request signal in a transmission frequency of α KHz in a predetermined cycle at first by the vehicle-mounted-device transmission unit 2 (step S2a of FIG. 5). The portable device 20 operates similarly to the procedure of FIG. 3. That is, in a case where the portable device 20 is not able to detect the response request signal by the portable-device reception unit 22 and detects the noise having the frequency of α KHz equal to or greater than a predetermined level by the noise detection unit 21a (step S12 of FIG. 3: NO), the portable device transmits the retransmission request signal to the vehicle-mounted device 10 by the portable-device transmission unit 23 (step S13 of FIG. 3). The portable device 20 switches the receiving target frequency of the LF signal from α KHz to β KHz by the reception frequency switching unit 22b (step S14 of FIG. 3).

If the retransmission request signal is received by the vehicle-mounted-device reception unit 3 (step S3 of FIG. 5: NO), the vehicle-mounted device 10 switches the transmission frequency of the response request signal from α KHz to β KHz by the transmission frequency switching unit 2b (step S4 of FIG. 5). The vehicle-mounted device 10 intermittently retransmits the response request signal in a transmission frequency of β KHz in a predetermined cycle by the vehicle-mounted-device transmission unit 2 (step S2a of FIG. 5).

As another example, the present invention may also be applied to a case where the portable device 20 transmits a remote operation signal based on the operation of the portable-device door switch 24 and then the vehicle-mounted device 10 that receives the remote operation signal transmits the radio signal (LF signal) in order to respond to the portable device 20.

Although it has been described in the above-described embodiment that the transmission frequencies are set such that the transmission frequency of the response request signal by the vehicle-mounted device 10 belongs to the LF band and the respective transmission frequencies of the response signal and the retransmission request signal by the portable device 20 belongs to the RF band, the present invention is not limited thereto. The respective transmission frequencies of the response request signal, the response signal, and the retransmission request signal may be set so as to belong to the LF hand, the RF band, or another band.

Although the door lock device 5 which locks or unlocks the doors of the vehicle 30 has been described as the target of which the operation is permitted or prohibited in the vehicle communication system 100 in the above-described embodiment that, the present invention is not limited thereto. In addition, for example, an operation of another vehicle-mounted target such as an engine device that starts or stops an engine of the vehicle, an air conditioning device that drives an air conditioner of the vehicle, an audio system, or an automatic opening and closing device of an open and close member such as a door may be permitted or prohibited.

Although it has been described in the above-described embodiment that the present invention is applied to the vehicle communication system 100, the vehicle-mounted device 10, and the portable device 20 for automatic four-wheeled vehicle, the present invention may also be applied to a vehicle communication system, a vehicle-mounted device, and a portable device for another vehicle such as an automatic two-wheeled vehicle or a large-sized automatic vehicle.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. A vehicle communication system comprising:
a vehicle-mounted device which is mounted on a vehicle and which comprises a vehicle-mounted-device transmission unit and a vehicle-mounted-device reception unit which transmits and receives radio signals, respectively;
a portable device which is carried by a user of the vehicle and which comprises a portable-device transmission unit and a portable-device reception unit which transmits and receives radio signals, respectively,
wherein the vehicle-mounted device transmits a response request signal by the vehicle-mounted-device transmission unit,
wherein the portable device transmits a response signal by the portable-device transmission unit in response to reception of the response request signal by the portable-device reception unit,
wherein the vehicle-mounted device permits or prohibits an operation of a target mounted on the vehicle based on the response signal received by the vehicle-mounted-device reception unit,
wherein the portable device further comprises a noise detection unit which detects a noise which disturbs reception of the response request signal by the portable-device reception unit,
wherein the vehicle-mounted device further comprises a transmission frequency switching unit which switches a transmission frequency of the response request signal transmitted by the vehicle-mounted-device transmission unit,
wherein the portable device transmits a retransmission request signal, which requests that the response request signal be retransmitted, by the portable-device transmission unit in a case where the portable device detects the noise by the noise detection unit and the response request signal is not able to be received by the portable-device reception unit, and
wherein the vehicle-mounted device switches the transmission frequency by the transmission frequency switching unit and retransmits the response request signal by the vehicle-mounted-device transmission unit in a case where the retransmission request signal is received by the vehicle-mounted-device reception unit.

2. The vehicle communication system according to claim 1,
wherein the transmission frequency of the response request signal belongs to a first frequency hand, and
wherein the respective transmission frequencies of the response signal and the retransmission request signal belong to a second frequency band different from the first frequency band.

3. The vehicle communication system according to claim 1,
wherein the portable device adds a switching instruction of the transmission frequency of the response request signal to the retransmission request signal, and transmits the retransmission request signal by the portable-device transmission unit.

4. The vehicle communication system according to claim 1,
wherein the portable device further comprises a reception frequency switching unit which switches a receiving target frequency of the response request signal to be received by the portable-device reception unit, and
wherein the receiving target frequency is switched by the reception frequency switching unit so as to match the transmission frequency of the response request signal to be retransmitted from the vehicle-mounted device later in response to transmission of the retransmission request signal by the portable-device transmission unit.

5. A vehicle-mounted device mounted on a vehicle, the vehicle-mounted device comprising:
a vehicle-mounted-device transmission unit and a vehicle-mounted-device reception unit which transmits and receives radio signals, respectively,
wherein a response request signal is transmitted to a portable device carried by a user of the vehicle by the vehicle-mounted-device transmission unit,
wherein a response signal, which is transmitted in response to reception of the response request signal by the portable device, is received by the vehicle-mounted-device reception unit to permit or prohibit an operation of a target mounted on the vehicle based on the response signal,
wherein the vehicle-mounted device further comprises:
a transmission frequency switching unit which switches a transmission frequency of the response request signal transmitted by the vehicle-mounted-device transmission unit,
wherein the transmission frequency is switched by the transmission frequency switching unit and the response request signal is retransmitted by the vehicle-mounted-device transmission unit in a case where a retransmission request signal, which requests retransmission of the response request signal and is transmitted in response to detection of a noise which disturbs the reception of the response request signal by the portable device, is received by the vehicle-mounted-device reception unit.

6. A portable device carried by a user of a vehicle, the portable device comprising:
a portable-device transmission unit and a portable-device reception unit which transmits and receives a radio signal, respectively,
wherein a response signal which permits or prohibits an operation of a target mounted on the vehicle to a vehicle-mounted device mounted on the vehicle is transmitted by the portable-device transmission unit in response to reception of a response request signal transmitted from the vehicle-mounted device by the portable-device reception unit,
wherein the portable device further comprises:
a noise detection unit which detects a noise which disturbs reception of the response request signal by the portable-device reception unit,
wherein the portable-device transmission unit transmits a retransmission request signal, which requests that the response request signal he retransmitted by switching a transmission frequency of the response request signal, to the vehicle-mounted device in a case where the noise is detected by the noise detection unit and the response request signal is not able to be received by the portable-device reception unit.

7. The portable device according to claim 6, further comprising:
a reception frequency switching unit which switches a receiving target frequency of the response request signal to he received by the portable-device reception unit,
wherein the receiving target frequency is switched by the reception frequency switching unit so as to match the transmission frequency of the response request signal to be retransmitted from the vehicle-mounted device later in response to transmission of the retransmission request signal by the portable-device transmission unit.
